(19) United States
(12) Patent Application Publication
(10) Pub. No.: US 2016/0007644 A1
(43) Pub. Date: Jan. 14, 2016

(54) Automatic Pressure Steam Canning Appliance

(71) Applicant: Hearthmark, LLC, Fishers, IN (US)

(72) Inventors: Gregary Hack, Boca Raton, FL (US); Scott Hager, MCordsville, IN (US)

(73) Assignee: Hearthmark, LLC, Fishers, IN (US)

(21) Appl. No.: 14/771,279

(22) PCT Filed: Mar. 12, 2014
(86) PCT No.: PCT/US14/24442

§ 371 Date: Aug. 28, 2015

Related U.S. Application Data
(60) Provisional application No. 61/779,788, filed on Mar. 13, 2013.

(51) Int. Cl. A23L 3/00; A23L 3/015

(52) U.S. Cl. CPC A23L 3/003; A23L 3/015

(57) ABSTRACT

An automatic pressure canning appliance for high-acid recipes has pre-programmed canning recipe programs (i.e., pre-determined times and temperatures) with which it has been programmed to can the high-acid food that the user wishes to can. A user selects the canning recipe program for the food to be canned via a canning recipe program input on a control panel of the appliance. The appliance processes the food to be canned (which is in jars in the appliance) in a pure steam environment for a pre-programmed processing time of the selected canning recipe program.

### FIELD

The present disclosure relates to an automatic canning appliance, and more particularly, to an automatic pressure steam canning appliance for canning high acid foods.

### BACKGROUND

This section provides background information related to the present disclosure which is not necessarily prior art.

“Canning” as that term is used herein is the processing of already prepared food recipes in jars to (1) evacuate the oxygen from the jars or food; (2) kill off any bad bacteria or microorganisms that can cause food spoilage; and (3) seal the jars to create a shelf stable product for up to 1 year without refrigeration or freezing. Typically canning has been done in using one of two types of canning appliances. A water bath canner is used for high-acid recipes (foods having a PH less than 4.6) or a pressure canner is used for low acid recipes (foods having a PH greater than 4.6). As used herein “high-acid recipes” are recipes for canning high-acid foods. Typical examples of high acid foods are: salsa's pickled cucumbers, jams, jellies, certain sauces (barbeque, pasta, etc.). Also as used herein, a “pure steam environment” is an environment where saturated steam exists with no air pockets present. This allows optimal heat transfer from the steam to the jar contents to heat the product up to a temperature where the microorganisms and bacteria are killed off.

### SUMMARY

This section provides a general summary of the disclosure, and is not a comprehensive disclosure of its full scope or all of its features.

In accordance with an aspect of the present disclosure, an automatic pressure canning appliance has a main body in which a pot is received. A heater is disposed in the main body in close proximity to the pot when the pot is received in the main body. A top lid is movable between open and closed positions and sealing to the pot when in the closed position. The pot and top lid when the top lid is in the closed position and sealed to the pot defining a pressure chamber. A pressure chamber vent has an inlet that opens to the pressure chamber and an outlet that opens to atmosphere. A primary temperature sensor senses a temperature in the pressure chamber. A control module has a plurality of pre-programmed canning recipe programs with each of the pre-programmed canning recipes having a pre-programmed processing time. The appliance has a canning recipe program selection stage followed by a heating stage followed by a processing stage followed by a cooing stage. The control module when the appliance is in the canning recipe program selection stage configured to be responsive to a user canning recipe program selection input via a control panel of the appliance to select one of the pre-programmed canning recipe programs. The control module configured to transition the appliance to the heating stage in response to a user start input via the control panel after selection of the pre-programmed canning recipe programs. The control module when the appliance is in the heating stage configured to energize the heater to heat the pressure chamber and to cycle the heater on and off to maintain the temperature in the pressure chamber sensed by the primary temperature sensor between an upper temperature set point and lower temperature set point that are both above a temperature at which water boils, wherein during the heating stage water received in the inner pot is boiled into steam and all air is vented from the pressure chamber via the vent creating a pure steam environment in the pressure chamber. The control module is configured to transition the appliance to the processing stage after the expiration of a predetermined heating time. When in the processing stage, the control module is configured to continue to cycle the heater on when the temperature sensed by the primary temperature sensor falls to the lower temperature set point and to cycle the heater off when the temperature sensed by the primary temperature sensor rises to the upper temperature set point and to transition the appliance to the cooling stage upon expiration of the pre-programmed processing time for the selected canning recipe program. The pure steam environment in the pressure chamber is maintained during the processing stage.

In an aspect, when the appliance is in the cooling stage, the control module is configured to de-energize the heater and the pressure chamber depressurizes to atmospheric pressure.

In an aspect, the appliance further includes a pre-heating stage that precedes the canning recipe program selection stage wherein in response to a user pre-heat input via the control panel, the control module is configured to energize the heater and in response to a pot temperature sensor sensing that a temperature of the pot is at or above a pre-heat temperature set point, the control module is configured to de-energize the heater for a short cooling period and then to reenergize the heater and configured to repeat de-energizing the heater for a short cooling period when the temperature of the pot is at or above the pre-heat temperature set point and then re-energize the heater after the short cooling period until a pre-heat period expires or the appliance has been transitioned to the canning recipe program selection stage in response to the user canning recipe program selection input.

In an aspect, the top lid includes a top plate and a bottom plate defining a loading chamber therebetween, the vent is a vent pipe extending through the bottom plate of the top lid and having an outlet above which a steam diffuser is disposed in spaced relation to the outlet of the vent pipe a distance to provide enough back pressure so that pressure in the pressure chamber can reach up to 8 psi at a higher elevation of 6000 feet above sea level. In an aspect, the steam diffuser is disposed 5 millimeters above the outlet of the vent pipe.

In an aspect, the top lid includes a drip ring is disposed around a lower periphery of the top lid that collects water that drips from the loading chamber of the top lid. In an aspect, the pot is an inner pot and the main body includes an outer pot in which the inner pot is received, the main body including a shell that surrounds the outer pot in spaced relation to the outer pot.

In an aspect, the upper temperature set point is in a range of 103° C. to 122° C. and the lower temperature set point is in the range of 95° C. 101° C. In an aspect, the upper temperature set point is 103° C. and the lower temperature set point is 101° C.

In an aspect, the appliance includes a secondary temperature sensor that also senses the temperature in the pressure chamber. The control module configured to read the temperature sensed by secondary temperature sensor when it reads the temperature sensed by the primary temperature sensor and configured to determine that a fault exits if there is more than a predetermined temperature difference between the temperature sensed by the primary temperature sensor and the temperature sensed by the secondary temperature sensor, the controller configured to terminate selected canning recipe program and shut the heater off upon determining that a fault exists.

In an aspect, the primary temperature sensor and the secondary temperature sensor are disposed at a bottom of the top lid.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an automatic pressure canning appliance in accordance of the present disclosure;

FIG. 2 is a cross-section view of the appliance of FIG. 1 taken along line 2-2 of FIG. 1; and

FIGS. 3A-3E are flow charts of an operation of the automatic canning pressure appliance of FIG. 1 including user interaction and control logic implemented in a control module of the automatic canning pressure appliance; and

Corresponding reference numerals indicate corresponding parts throughout the several views of the drawings.

### DETAILED DESCRIPTION

Example embodiments will now be described more fully with reference to the accompanying drawings.

A purpose of a canning appliance in accordance with an aspect of the present disclosure to provide an automatic pressure canning appliance for high-acid recipes, referred to herein as the “appliance.” In accordance with an aspect of the present disclosure, the appliance has a 3 button programming approach that allows a user to easily and quickly select the particular food being canned and then walk away. This means that the user needs only to know some basic canning principles of how the automatic pressure canner operates to be able to can food using the automatic pressure canner. Based on a food type “category” and a “program” number selected, the appliance uses pre-programmed recipes (i.e., pre-determined times and temperatures) with which it has been programmed to can the high-acid food that the user wishes to can. This allows the high acid food to be processed inside its jar for a set amount of time. This ensures evacuation of air from the jar containing the food being canned, extermination of harmful bacteria from the food, and sealing between the jar and a top lid of the jar. Based on achieving the above three criteria, the canned food can be stored on a shelf (non-refrigerated environment) for up to a year.

Another purpose of the appliance in accordance with an aspect of the present disclosure is the elimination of the water bath canning process that is traditionally done on a stove and instead use a steam canning process for canning high acid foods. This means that the heat is transferred into the jars and their contents (the food) through the heat given off by steam instead of the heat given off by boiling water. Using steam as a heating processing medium is a more stable and efficient process than traditional water bath canning. In accordance with an aspect of the present disclosure, the appliance creates a pure steam environment (no air inside the heating chamber), pressurizes a vessel to achieve exact temperatures required to process the food for a set period of time, controls the canning process more accurately using temperature sensors, and can achieve the same temperatures at altitude as at sea level.

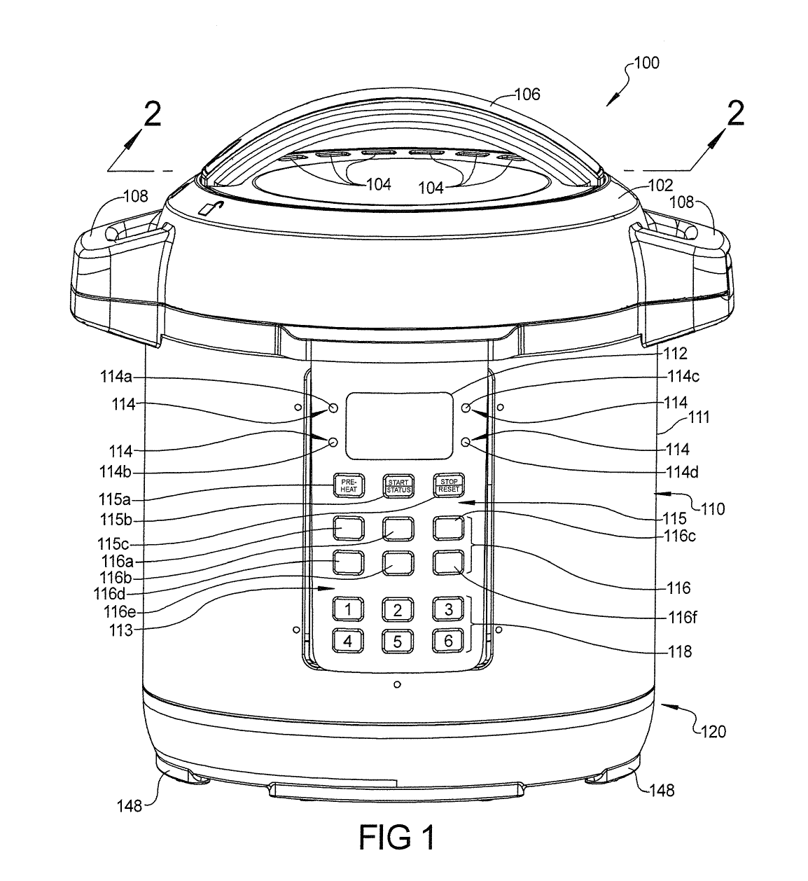

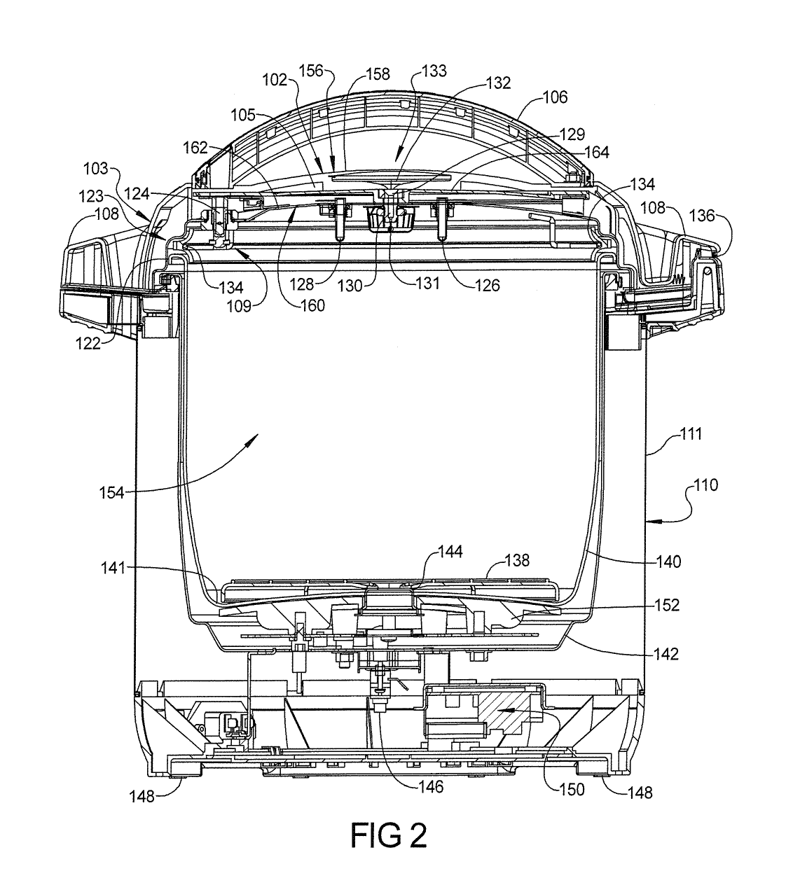

With reference to FIGS. 1 and 2, an automatic pressure canning appliance 100 in accordance with an aspect of the present disclosure is described. Appliance 100 has a top lid 102. As shown in FIG. 2, top lid 102 includes a top 156 defined by a top plate 158, a bottom 160 defined by a bottom plate 162 and an intermediate plate 164 disposed between top plate 158 and bottom plate 162. Top plate 158 and intermediate plate 164 define a loading chamber 105 therebetween. Top lid 102 includes rear vents 104 extending through top plate 158. Rear vents 104 provide an area where escaping steam vents out of appliance 100. The steam originates inside an inner pot 140 (FIG. 2) flows through a vent pipe 130 (FIG. 2) and expels to the atmosphere through the rear vents 104. Top lid 102 has a top handle 106 that is grasped by a user to rotate the top lid 102 open and closed. The top handle 106 can also be grasped by a user to carry the appliance 100. Top lid 102 also has side handles 108 that a user can grasp to move or manipulate the position of appliance 100. Side handle 108 on a right (as oriented in FIG. 2) of top lid 102 also includes a hinge 136 by which top lid 102 is hingedly fastened to main body 110 of appliance 100.

Main body 110 is made up of various components of appliance 100, specifically including an inner pot 140, and outer pot 142, and an outer shell 111 that surrounds outer pot 142 in spaced relation to outer pot 142. Outer shell 111 is illustratively made of stainless steel, but could be made from other materials such as plastic. A control panel 113 is disposed in main body 110 and includes a user interface display 112, status lights 114, control buttons 115, food category buttons 116 and program number buttons 118. User interface display 112 is used to display all relevant information necessary to communicate with a user of appliance 100 relating to: time, progress, temperature, faults, and program information. Illustratively, the user interface display 112 is an LCD display. It should be understood that user interface display 112 can be displays other than an LCD display. Status lights 114 are illustratively disposed on both sides of user interface display. The status lights 114 display at what stage the canning process that appliance 100 is operating to perform is at and light up at specific stages during the canning process to inform the user what stage the canning process is at. Status lights 114 are illustratively light emitting diodes (“LEDs”), but can be other than LEDs. Status lights 114 illustratively include a “Pre-Heating” LED 114a, a “Sensing” LED 114b, a “”Preserving” LED 114c and a “Ready” LED 114d.

Control buttons 115 are illustratively immediately below user interface display 112. Illustratively, control buttons 115 include a Pre-Heat button 115a, a Start/Status button 115b and a Stop/Reset button 115c.

Food category buttons 116 are illustratively disposed immediately below control buttons 115. There is illustratively a food category button 116 for each food category that can be canned by appliance 100. By way of example, the food categories include jams/jellies (button 116a), fruits (button 116b), tomatoes (button 116c), salsas (button 116d), pickles (button 116e) and sauces (button 116f). It should be understood that there can be more than or fewer than six food categories and include food categories other than the foregoing, Food category buttons 116 are used in the first step of selecting the canning process to be performed by appliance 100 and are used to select which category of food appliance 100 will be processing. Once selected, such as by a user pushing it, the selected food category button 116 will stay illuminated during the canning process.

Program number buttons 118 are illustratively disposed immediately below food category buttons 116. Program number buttons 118 are used in the second step of selecting the canning process to be performed by appliance 100 and are used to select which recipe for the selected food category will be used. Once a user selects a food category, the user selects the recipe to be used to can the food by selecting the appropriate program number button, such as pushing it. The selected program number will stay illuminated during the canning process once it has been selected. It should be understood that food category buttons 116 and program number buttons 118 are illuminated buttons, meaning that they are buttons that illuminate once selected. In the example shown, there are six food category buttons 116 and six program number buttons 118. It should be understood that there can be more or less than six food category buttons 116 and program number buttons 118.

Appliance 100 also includes a base 120 which illustratively houses the electronics, heater 152 and controls (other than user interface display 112, food category buttons 116, and program number buttons 118) for appliance 100. In this regard, a control module 150 (discussed in more detail below) that controls appliance 100 is housed in base 120 and is coupled to control panel 113 and the various components of appliance 100, such as NTCs #1-#3 and heater 152, that are controlled by control module 150 or provide inputs to control module 150.

As best shown in FIG. 2, top lid 102 includes a drip ring 122 disposed around a lower periphery 123 of top lid 102. Drip ring 122 is an area where water condensation in loading chamber 105 in top lid 102 that occurs as a result of steam diffusing through the rear vent holes collects and then flows to a drip cup (not shown).

Appliance 100 also includes a lift valve assembly 124 disposed in top lid 102, illustratively near an outer periphery 103 of top lid 102 in proximity to a top 109 of main body 110. The lift valve assembly 124 includes a pressure operated valve that under a very low pressure will lift up a locking member that locks top lid 102 from being rotated when top lid 102 is in its closed position. This prevents a user from opening top lid 102 while appliance 100 is under steam pressure as top lid 102 must be rotated to its unlocked position in order to open it, as discussed below.

Appliance 100 also includes a primary temperature sensor 126 disposed at bottom 160 of top lid 102 that senses the temperature in pressure chamber 154. Primary temperature sensor 126 is illustratively mounted to the bottom plate 162 of top lid 102. Primary temperature sensor 126 illustratively is a negative temperature coefficient (“NTC”) sensor and referred to herein as NTC #1.: NTC#1 is the primary temperature controlling sensor. NTC #1 is used by control module 150 to check the temperature of the steam inside the inner pot 140 every 0.1 seconds and compares it to set points in its control logic. If the temperature sensed by NTC#1 is too hot, control module 150 will switch off the heater 152. If the temperature sensed by NTC #1 is too cold, control module 150 will switch on the heater 152. This is done to maintain steady temperature tolerances inside the pressurized pressure chamber 154 in appliance 100 defined by closed top lid 102 and inner pot 140 when top lid 102 is closed and appliance 100 is pressurized with steam.

A secondary temperature sensor 128 is also disposed at bottom 160 of top lid 102, and illustratively mounted to bottom plate 162 of top lid 102. Secondary temperature sensor 128 illustratively is also a NTC sensor as referred to herein as NTC #2. NTC #2 is the secondary temperature controlling sensor. NTC #2 is used by control module 150 to check the temperature value that NTC #1 by comparing the temperature that NTC #1 is sensing with the temperature that NTC #2 is sensing. This ensures that whatever steam temperature is being sensed inside appliance 100 unit is correct. If the two temperatures don't match (within acceptable tolerances), control module 150 puts appliance 100 in a fault condition where appliance 100 is shut down.

A vent pipe 130 is disposed in top lid 102, illustratively at a center 133 of top lid 102. Vent pipe 130 is illustratively a small diameter pipe, and illustratively has a diameter of 1 mm but could have a slightly larger or smaller diameter. Appliance 100 is constantly venting steam through vent pipe 130 during the processing portion of a canning process. This ensures that a pure steam environment is always present in pressure chamber 154 during the food processing stage of the canning process in which the food in the canning jars in appliance 100 is processed. A steam diffuser 132 is disposed in top lid 102 above vent pipe 130. The steam diffuser 132 is a cone shaped plastic piece that redirects the steam jet emitted by the vent pipe 130 in a 360 degree pattern and diffuses it into a large area—loading chamber 105—beneath the top lid 102. The steam is then free to trickle out gently from the rear vents 104 at the back of the top lid 102.

Seal 134 is an annular seal that extends around a bottom of top lid 102 near outer periphery 103 of top lid 102 and seals top lid 102 to inner pot 140 when top lid is closed to create pressure chamber 154. Seal 134 is illustratively silicone and capable of handling the maximum pressure in pressure chamber 154 with little to no leakage.

Canning rack 138 is in inner pot 140 at a bottom 141 of inner pot 140. The canning 138 rack is used to hold jars containing food being canned off the bottom 141 of the inner pot 140 to prevent the jars from coming into contact with a very hot bottom 141 of the inner pot 140. This helps prevent thermal shock on the glass jars.

The inner pot 140 is the container where the jars and canning rack 138 are housed. This is the area where the jars are exposed to the hot steam needed to sterilize their contents.

The inner pot 140 fits inside the outer pot 142. In an aspect, many of the components of appliance 100 including the heater 152, mountings, etc. are fixed to the outer pot 142. The top lid 102 locks to the base through large teeth that interlace with corresponding teeth in a top edge of the outer pot 142. These teeth rotate over one another to lock top lid 102 in place and keep the top lid closed under steam pressure. When top lid 102 is moved from its open to closed position, a user then twists top handle 106 to rotate top lid 102 on main body 110 to rotate the teeth of top lid 102 and corresponding teeth of outer pot 142 over one another to lock top lid 102 in place. In order to open top lid 102, it must be rotated to an unlock position where its teeth are disengaged from the teeth of outer pot 142.

A pot bottom temperature sensor 144 is disposed in base 120 immediately beneath bottom 141 of inner pot 140 and senses the temperature of bottom 141 of inner pot 140. Pot bottom temperature sensor 144 illustratively is also a NTC and referred to herein as NTC #3: The pot bottom NTC #3 is there to check for a dry pot condition. It is a thermal sensor similar to the NTC #1 and NTC #2 but with a different casing. Its primary role is to ensure that there is water present in the inner pot 140. If none is present, the temperature sensed by NTC #3 will be too high resulting in control module 150 putting appliance 100 in a fault condition where appliance 100 is shut down.

While temperature sensors 126, 128 and 144 are described as being NTC temperature sensors, it should be understood that they can be other types of temperature sensors.

Pressure switch 146 is disposed in base 120 and is responsive to pressure in pressure chamber 154. The pressure switch 146 is a safety device that in the unlikely event that the pressure inside the inner pot 140 rises too high, the pressure switch 146 will cut the electrical connection to heater 152 and control module 150 responsive to this will put appliance 100 in a fault condition. This will stop any further operation of appliance 100 including heating until appliance 100 returns to normal conditions.

The base feet 148 are used to stabilize appliance 100 in any orientation. They help prevent appliance 100 from slipping on a counter or toppling over when the lip is opened.

In an aspect, while appliance 100 could be considered a modification of a typical prior art pressure cooker, there are significant differences between appliance 100 and a typical prior art pressure cooker. The primary differences between a typical prior art pressure cooker and appliance 100 are:

a) Appliance 100 can maintain much tighter temperature controls and tolerances than a pressure cooker;

b) Appliance 100 vents air/steam continuously through a vent hole (or bleeder) (such as vent pipe 130) to evacuate all air from the pressure chamber and achieve a pure steam environment to process the jars containing food to be canned;

c) Appliance 100 uses NTC sensors in top lid 102 while in a pressure cooker temperature it is controlled through either a series of pressure switches or a temperature sensor in the base of the unit;

d) A pressure cooker heats up and cooks food whereas appliance 100 heats up a small volume of water to create a pressurized steam environment;

e) A pressure cooker does not require precise pressure and temperature to cook food whereas appliance 100 uses a much precise temperature range to process its jars and food contents therein.

It is important to note that unlike a pressure cooker, the food is not put inside the inner pot of appliance 100 and cooked. Rather in appliance 100, the food is placed in jars with lids with the jars placed in inner pot 140. A small volume of water is placed in the inner pot 140 and heated to create steam and pressure. Appliance 100 does not cook the food; it creates a sterile environment under which the food becomes shelf stable.

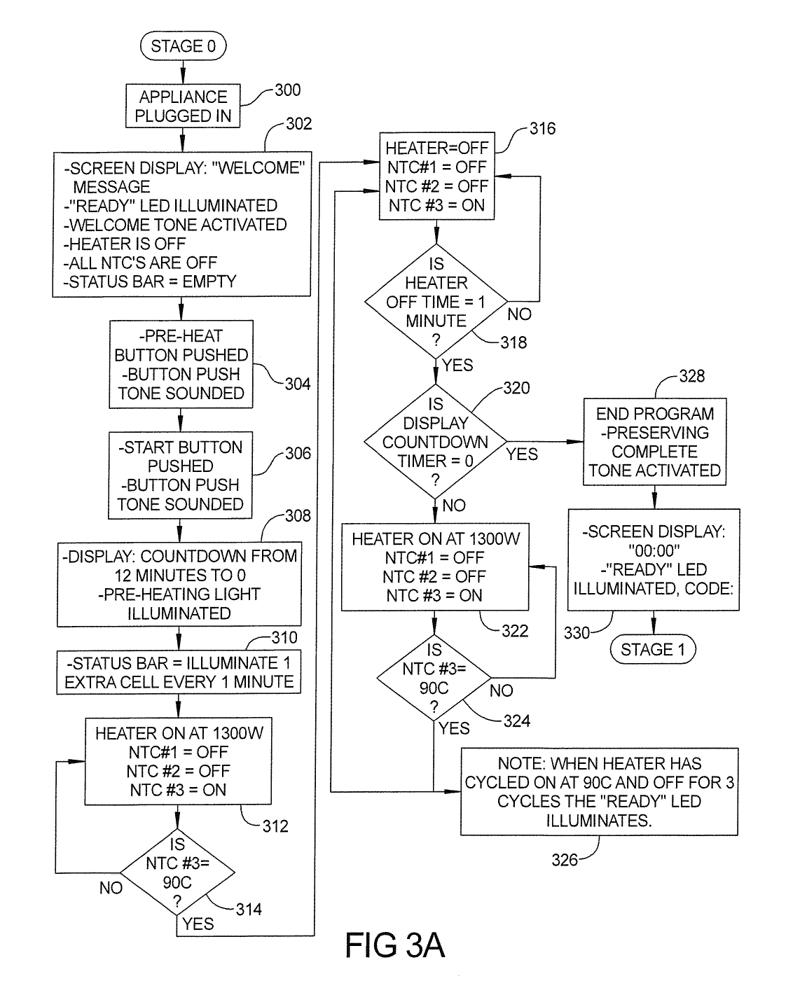

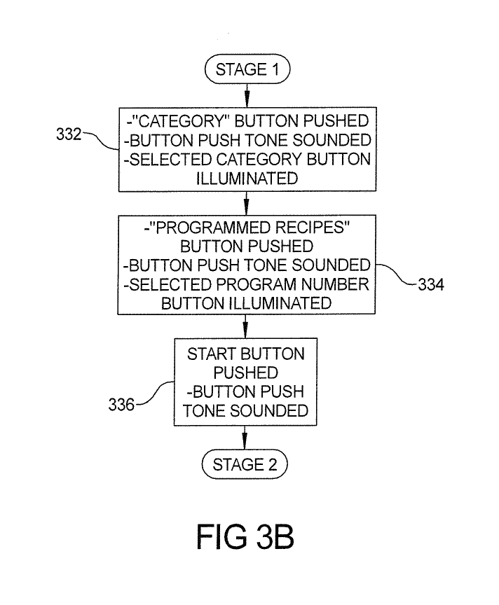

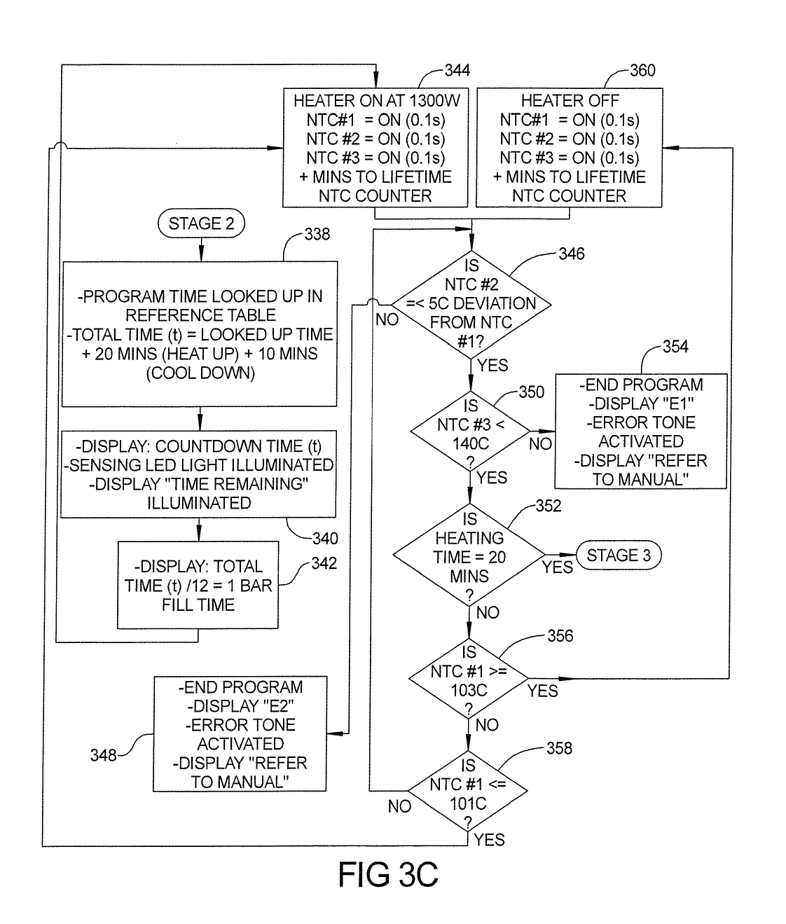

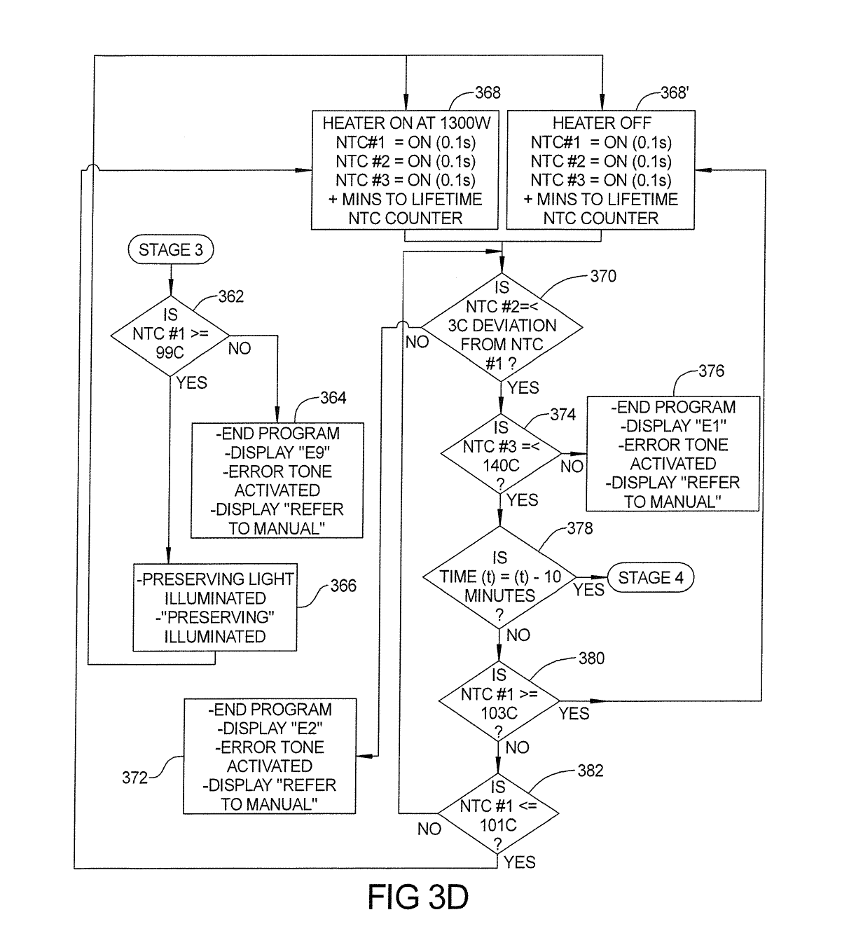

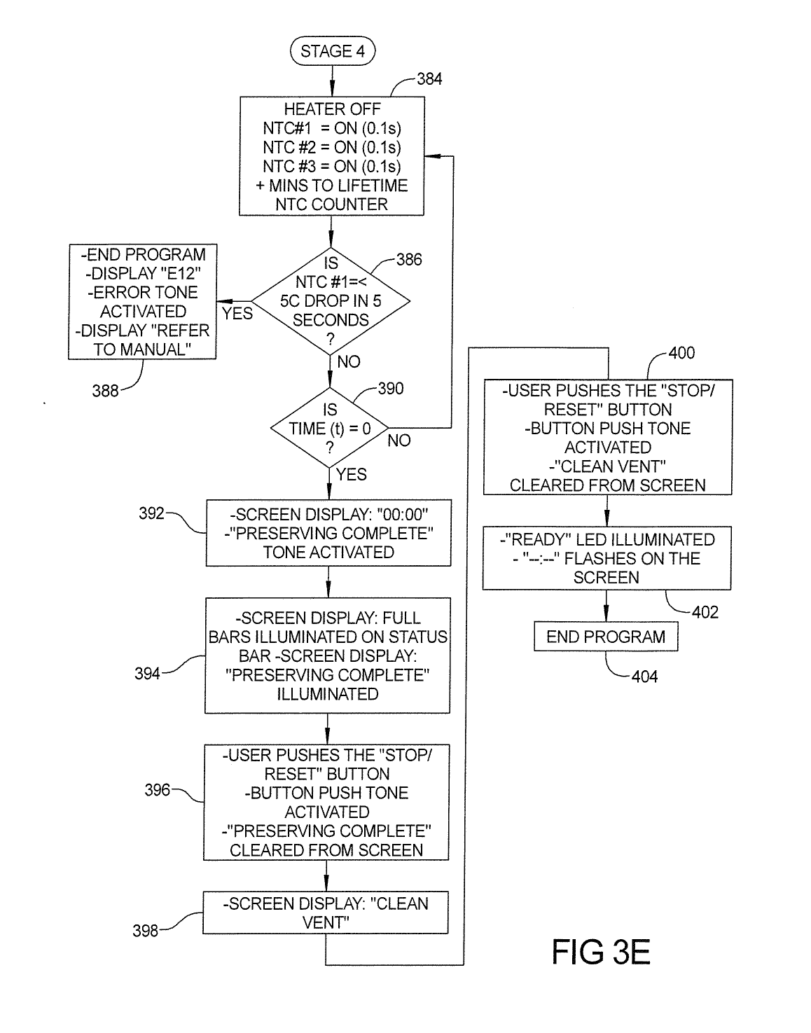

With reference to FIGS. 3A-3E, operation of appliance 100 for a canning process is described. FIGS. 3A-3E are flow charts showing both the actions a user takes in operating appliance 100 and logic implemented in control module 150 for the control of appliance 100 to cause it to perform the canning process. There are five principal stages in the operation of appliance 100 to perform a canning process: appliance preparation and pre-heat (Stage 0), canning recipe program selection (Stage 1); heating (Stage 2); processing where the food in the jars is being processed (Stage 3); and cooling (Stage 5). The reference numbers refer to the blocks in the flow charts of FIGS. 3A-3E.

With specific reference to FIG. 3A, Stage 0 (appliance preparation and pre-heat) is described. During the pre-heat, appliance 100 is warmed up, inner pot 140 in particular as well as the canning jars that are placed on the canning rack 138 prior to starting the pre-heating stage. Pre-heating the canning jars reduces the thermal shock when the food to be canned is placed in the canning jars.

At 300, the user plugs appliance 100 into a source of power, such as a wall outlet, which turns appliance 100 on. It should be understood that appliance 100 could be provided with an on/off switch that would then be used to turn appliance 100 on. At 302, a “Welcome” message is displayed on display 112, the Ready LED 114d is flashing and a “Welcome” tone sounded. In this regard, control module illustratively causes the Welcome message to display on display 112, the flashing of Ready LED 114d and the sounding of the Welcome tone. Heater 152 is off, NTCs #1-#3 are off and a status bar (not shown) displayed on display 112 is empty (i.e. no cells illuminated). As used herein, an NTC being off means that it is not energized by control module 150 and an NTC being on means that it is energized by control module 150 and being used by control module 150 to sense temperature. The user then prepares appliance 100 by inserting the following into the inner pot 140: 48 oz (1420 ml) of water (at room temperature), canning rack 138, and canning jars on top of the canning rack 138. The user then places inner pot 140 containing the jars, water and canning rack 138 into the outer pot 142. The user then closes top lid 102 and rotates it to lock top lid 102. At 304, the user selects “Pre-Heat” by pressing the Pre-Heat button 115a to warm up the water and jars. When the user presses the Pre-Heat button 115a, a button push tone is sounded. Once the user presses the Pre-Heat button 115a, it illuminates at 310 and stays illuminated for the duration of a pre-heating stage. In this regard, control module illustratively controls the illumination of Pre-Heat button 115a and illuminates it in response to Pre-Heat button 115a being pressed as well as sounding the button push tone. Illustratively, the Start/Status and Stop/Reset buttons 115b, 115c buttons are not illuminated when pressed.

At 308, control module 150 responds to Pre-Heat button 115a being pushed by starting a twelve minute pre-heat countdown timer. At 310, control module 150 displays numerically the remaining time in the pre-heat countdown timer on display 112 and illuminates Pre-Heating LED 114a. At 310, control module 150 illuminates an additional cell on the status bar displayed on display 112, with the last cell illuminated being flashed. At 312, control module 150 turns heater 152 on at full power, illustratively, 1300 watts, keeps NTC#1 and NTC#2 off and turns NTC#3 on. At 314, control module 150 checks whether the pot bottom temperature sensed by NTC #3 is at or above a pre-heat temperature set point, illustratively ninety degrees C. or greater (which set point will be referred to hereafter as 90° C.). If not, control module 150 branches back to 312. If the pot temperature sensed by NTC #3 is at or above 90° C., control module 150 branches to 316 where it turns heater 152 off. NTC#1 and NTC#2 remain off and NTC#3 remains on. At 318, control module 150 checks whether heater 152 has been off for one minute. If not, control module 150 branches back to 316. If heater 152 has been off for one minute, control module 150 proceeds to 320 where it checks whether the twelve minute countdown timer has reached zero. If the twelve minute countdown timer has not reached zero, control module 150 proceeds to 322 where it turns heater 152 back on at its full power. NTC#1 and NTC#2 remain off and NTC#3 remains on. At 324, control module 150 control module 150 checks whether the pot bottom temperature sensed by NTC #3 has reached 90° C. If not, control module 150 branches back to 322. If the pot temperature sensed by NTC #3 has reached 90° C., control module 150 branches back to 316. Also, if heater 152 has been cycled on and off for three cycles, at 326 control module 150 illuminates Ready LED 114d. If at 320 the twelve minute countdown timer has reached zero, control module 150 proceeds to 328 which ends Stage 0, sounds a preserving complete tone and proceeds to 350 where it displays “00:00” on display 112 and illuminates Ready LED 114d. It should be understood that the above process of cycling heater 152 on and off continues for three cycles, until the user cancels the pre-heating process by pushing Stop/Reset button 115c, or until the user transitions appliance to Stage 1 by selecting a food category for the category of food to be canned. After three cycles of cycling heater 152 on and off, the canning jars are sufficiently warm and can be removed by the user to place the food to be canned in them.

Prior to proceeding to Stage 1, a user will place the hot cooked food to be canned in the jars, secure the lids and bands to the jars and place the jars back inside inner pot 140 on canning rack 138.

Stage 1 begins at 332 by a user selecting a food category of food to be canned by pushing a desired food category button 116. Upon the user pushing a food category button, control module 150 sounds a button push tone and illuminates the food category button 116 that the user pushed, such by control module 150 switching on a back lit LED (not shown) behind that food category button 116. Ready LED 114d remains flashing throughout Stage 1. The selected food category button 116 will remain illuminated throughout the canning process. At 334, the user selects the desired canning recipe program to be used for the canning process by selecting a program number button 118 by pushing it. Control module 150 illuminates the program number button 118 that was pushed, illustratively by switching on a back lit LED (not shown) behind that program number button 118, which will remain illuminated throughout the canning process. Control module 150 also sounds the button pushed tone. The canning recipe program selection of Stage 1 thus involves a user selecting the desired food category, by pushing the appropriate Food Category button 116, and the desired program number, by pushing the desired program number button 118.

The canning recipe program that can be selected corresponds to a processing time that is pre-programmed into the logic of control module 150 (such as in a memory of control module 150 or that control module 150 accesses) for the particular canning recipe program. The times for the canning recipe programs are illustratively determined heuristically, such as by testing. Each canning recipe program selected will have its own time associated with a “Food Category” and “Program Number” combination. For example, if “Jam/Jelly” is selected from the Food Categories by a user pressing the Jam/Jelly Food Category button and recipe program “1” is selected from the Program Numbers by the user pressing Program Number button 1, this illustratively corresponds to a processing time (in Stage 3) of 5 minutes. This time does not include warm up or cool down of appliance 100. The total program time (“Total Program Time”) for a Recipe Program is made up of a total of three times: A warm-up time fixed at twenty minutes, a processing time which is programmed into the logic of control module 150 for each recipe and is retrieved based on the Food Category and Recipe Program selected, and a cool down time which is also programmed into the logic of control module 150 for each recipe and is retrieved based on the Food Category and Recipe Program selected. Illustratively, the cool down time is eight minutes for Recipe Programs 1 and 2 in the Jam & Jellies Food Category and is otherwise ten minutes.

At 336, the user then presses the Start/Status control button 115b once to initiate the heating stage for the selected canning recipe program, which transitions appliance 100 to Stage 2 (heating). Control module 150 sounds a button push tone when Start/Status control button 115b is pushed and also illuminates Sensing LED 114b, which remains illuminated during Stage 2. At 338, control module 150 responds to the Start/Status control button 115b being pressed once to initiate the selected canning recipe program by retrieving the pre-programmed processing time for the selected Food Category and Recipe Program number and proceeds to 340 where control module 150 begins counting down the Total Program Time for the selected Food Category and Recipe Program determined as described above, and at 342 displays on display 112 the remaining time in the Total Program Time as it is counted down referred to herein as Time Remaining (t) and also displays the Time Remaining (t) on the status bar displayed on display 112 by illuminating an additional cell on the status bar displayed on display 112 after the lapse of each time interval of (t)/12.

At 344, control module turns heater 152 on at full power and appliance 100 continues to heat as control module 150 begins reading the temperature in inner pot 140 immediately below top lid 102 sensed by NTC #1 and NTC #2. At this point, control module 150 is reading the temperatures sensed by the NTC's #1-#3 at their respective intervals, which are illustratively the same intervals (NTC #1 at 0.1 s NTC #2 at 0.1 s; NTC #3 at 0.1 s). At 346, control module 150 compares the temperature sensed by NTC #2 against the temperature sensed by NTC #1 and if more than the predetermined temperature difference exists between NTC #1 and NTC #2, control module 150 determines that a fault has occurred and branches to 348 where it ends processing of the canning recipe program turning heater 152 off, displaying an error message “E2” on user interface display 112 and also displaying a “Refer to Manual” message on display 112. The predetermined temperature difference is illustratively determined heuristically by testing, and may for example be approximately 5° C. The messages are, for example, displayed until the user pushes and holds the Stop/Reset button 115c for a predetermined period of time such as two seconds.

At 350 control module 150 monitors the temperature at bottom 141 of inner pot 140 by reading the temperature sensed by NTC #3 and determines whether this temperature is less than a dry pot temperature (which is illustratively determined heuristically), and for example is 140° C. If not, this elevated temperature indicates that inner pot 140 is dry and control module 150 branches to 354 where it ends processing of the canning recipe program turning heater 152 off and displaying an error message “E1” on user interface display 112 and also displaying a “Refer to Manual” message on display 112. At 352, control module 150 checks whether the heating time of twenty minutes has expired (that is, whether twenty minutes has elapsed in the recipe program count time (t). If not, at 356, control module 150 checks whether the temperature sensed by NTC #1 has reached an upper temperature set point, which is illustratively 103° C. (which should be understood as 103° C. +/−typical tolerances). If so, control module 150 branches to 360 where it turns heater 152 off and continues to read the temperatures sensed by NTC's #1-#3 at their respective intervals and then branches to 344. If at 358 control module 150 determined that the temperature sensed by NTC #1 has not reached the upper temperature setpoint of 103° C., control module 150 proceeds to 358 where it checks whether the temperature sensed by NTC #1 has fallen below a low temperature setpoint, illustratively 101° C. If so, control module 150 branches back to 344. If not, control module 150 branches back to 344. It should be understood that the upper temperature set point could be slightly higher or lower than 103° C. as long as it is higher than the lower temperature set point and the lower temperature set point could be slightly higher or lower than 101° C. as long as it is at least the temperature at which water boils (which can be slightly lower than 100° C. at higher elevations). In an aspect, the lower temperature set point is in the range of 95° C. to 101° C. and the upper temperature set point is in the range of 103° C. to 122° C.

During Stage 2, as the water in inner pot 140 boils, air and steam are purged from pressure chamber 154 through vent pipe 130 to evacuate all air from pressure chamber 154 and thus from the inner pot 140 to create a pure steam environment in pressure chamber 154 in inner pot 140. A pure steam environment means that only steam is present.

If at 352 control module 150 determined that the heating time has reached twenty minutes, control module 150 branches to 362 transitioning appliance 100 to Stage 3 (processing). Stage 3 (processing) is done in a pure steam environment. The duration of this stage is the time corresponding to the Food Category and Recipe Program selected during Stage 1. Control module 150 maintains the 101° C. to 103° C. temperature in pressure chamber 154. The time of Stage 3 corresponds to how long it takes to heat the entire contents of the jars in inner pot 140 to an acceptable temperature and hold it there for a set period of. This condition is what kills off the bacteria in the jar, evacuates the oxygen and creates and environment where the jar will become shelf stable for up to one year.

At 362, control module 150 checks whether the temperature sensed by NTC #1 is above a low temperature error threshold, illustratively 99° C. If not, this is indicative either that the user has not performed a step correctly (such as putting cold water in appliance 100 with a cold product) or that appliance 100 has experienced a fault, and control module 150 branches to 364. At 364, control module 150 ends processing of the canning recipe program by turning heater 152 off, displays an error message “E9” on display 112, sounds an error tone and also displays a “Refer to Manual” message on display 112.

If at 362 control module 150 determines that the temperature sensed by NTC#1 is above the lower temperature error threshold of 99° C., control module 150 then proceeds to 366 to continue with Stage 3. In Stage 3, the food in the canning jars in appliance 100 is processed as described above. Control module 150 cycles heater 152 on and off during Stage 3, cycling heater 152 on when the temperature sensed by NTC #1 falls to 101° C. and off when the temperature sensed by NTC #1 rises to 103° C.

At 366, control module 150 illuminates Preserving LED 114c and displays the text “Preserving” on display 112, both of which remain during Stage 3. Control module 150 then proceeds to 368 if heater 152 is on or 368′ if heater 152 is off and continues to read temperatures from NTCs #1-#3 at their respective intervals (0.1 sec. each). At 370, control module 150 compares the temperature sensed by NTC #2 against the temperature sensed by NTC #1 and if more than the predetermined temperature difference of approximately 3° C. exists between NTC #1 and NTC #2, control module 150 determines that a fault has occurred and branches to 372 where it ends processing of the canning recipe program turning heater 152 off, displaying an error message “E2” on user interface display 112 and also displaying a “Refer to Manual” message on display 112. The messages are, for example, displayed until the user pushes and holds the Stop/Reset button 115c for a predetermined period of time such as two seconds.

At 374 control module 150 monitors the temperature at bottom 141 of inner pot 140 by reading the temperature sensed by NTC #3 and determines whether this temperature is less than the dry pot temperature of (140° C. If not, this elevated temperature indicates that inner pot 140 is dry and control module 150 branches to 376 where it ends processing of the canning recipe program turning heater 152 off and displaying an error message “E1” on user interface display 112 and also displaying a “Refer to Manual” message on display 112. At 378, control module 150 checks whether the countdown time has reached the point where it has only the cool down time for the selected Food Category and Recipe Program left (such as eight or ten minutes as discussed above). If not, at 380, control module 150 checks whether the temperature sensed by NTC #1 has reached an upper temperature set point, which is illustratively 103° C. (which should be understood as 103° C. +/−typical tolerances). If so, control module 150 branches to 368′ where it turns heater 152 off and continues to read the temperatures sensed by NTC's #1-#3 at their respective intervals and then branches to 370. If at 380 control module 150 determined that the temperature sensed by NTC #1 has not reached the upper temperature setpoint of 103° C., control module 150 proceeds to 382 where it checks whether the temperature sensed by NTC #1 has fallen below a low temperature setpoint, illustratively 101° C. If so, control module 150 branches back to 368 where it turns heater 152 on and continues to read the temperatures sensed by NTC's #1-3 at their respective intervals and then branches to 370 If not, control module 150 branches back to 368.

If at 378 control module 150 determined that the countdown time has reached the point where it has only the cool down time for the selected Food Category and Recipe Program left, control module 150 branches to 384 transitioning appliance 100 to Stage 4 (cooling). At 384, control module 150 turns heater 152 off and continues to read temperatures from NTCs π1-#3 at their respective intervals (0.1 sec. each). At 386, control module 150 checks whether the temperature sensed by NTC #1 has dropped 5° C. or more during a period of five seconds (which indicates that lid 102 has been opened). If so, control module 150 determines that a fault has occurred and branches to 388 where it ends processing of the canning recipe program turning heater 152 off, displaying an error message “E12” on user interface display 112 and also displaying a “Refer to Manual” message on display 112. The messages are, for example, displayed until the user pushes and holds the Stop/Reset button 115c for a predetermined period of time such as two seconds. If at 386 the temperature sensed by NTC#1 did not drop 5° C. or more during a period of five seconds, control module 150 proceeds to 390 where it checks whether the countdown time has reached zero. If not, control module 150 branches back to 384. If at 390 the countdown time has reached zero, control module 150 proceeds to 392 where it displays “00:00” on display 112 and sounds a “Preserving Complete” tone followed by three button pushed tones, illustratively one every thirty seconds. Next at 394 all the cells on status bar displayed on display 112 are illuminated by control module 150 to show that the canning process has successfully completed and control module 150 displays “Preserving Complete” on display 112. At 396, the user must then push Stop/Reset button 115c. Control module 150 responds by sounding the button pushed tone and also clears the cells of the status bar displayed on display 112 and the “Preserving Complete” message on display 112. Next at 398 control module 150 displays “Clean Vent” on display 112.

Next at 400, the user must again push Stop/Reset button 115c which resets appliance 100 back to the beginning of Stage 0. Control module 150 also sounds the button pushed tone and clears the “Clean Vent” message on display 112. At 402, control module 150 causes Ready LED 114d to be flashing and at 404, the canning processing program ends.

Top lid 102 can be opened once the lift valve of lift valve assembly 124 has dropped at atmospheric pressure and the countdown time has reached zero.

An attribute of appliance 100 is its ability to operate at the same temperatures regardless of the altitude it is operating at. When water bath canning, water cannot reach temperatures above its boiling point. At sea level this is around 100° C. but at altitude, example 6000 ft., this temperature is reduced to 95° C. The reduced temperature when boiling water at higher elevations means that a lower temperature is reached when processing jars in a water bath canner. This is compensated for by adding time to higher elevation processes. Appliance 100 eliminates these temperature adjustments by the above described control of the process between two temperatures regardless of elevation above sea level. It does this through the simple scientific principle that if you increase the pressure inside a closed container, temperature will increase proportionately. Thus, appliance 100 will keep heating the water at 6000 ft until the pressure is around 3-4 psi (but which can be as high as 8 psi), which corresponds to a temperature of 103° C. Once appliance 100 reaches this temperature set point, it will switch heater 152 off until the temperature falls to the set point of 101° C., which corresponds to a pressure of 2 psi. This process remains the same for sea level, however at sea level the water boils at 100° C. When heating to 100° C. at sea level, appliance 100 will only see pressures of around 2 psi. Appliance 100 will thus process the food at the same temperature bounds regardless of altitude. This will yield consistent product results as appliance 100 is utilizing the same processing techniques and temperatures at both sea level and higher elevations.

The above described venting of appliance 100 is significantly different to other pressure cookers. Most pressure cookers have a vent with a weight vale sitting on top of the exit vent pipe. This regulates the pressure inside of the cooking vessel. In most of the cases this weight valve doesn't let off much steam during the pressure cooking process as the process is controlled by pressure switches that control the pressure under the limits of what is necessary to activate the weight valve. In pressure cooker terms the weight valve and vent pipe are safety release mechanisms activated only if the pressure in the machine becomes too high.

In the case of the stove top pressure canners, some have a bleeder valve and the weight valve/vent pipe combination. The bleeder is usually very small (around 0.5 mm in diameter) and is used to vent out any air given off by the jars during the canning process. This maintains a pure steam environment inside the stove top pressure canner. The jet of steam emitted from the 0.5 mm bleeder is usually very intense and hot.

Appliance 100 does a similar task, only it does so with the use of only a small diameter vent pipe. There is no weight valve present in the system or additional bleeder. Instead the operating pressures inside appliance 100 are very low (typically 3-4 psi at 6000 ft above sea level but can be as high as 8 psi) so there is very little need for appliance 100 to have back pressure as provided by a typical weight valve. This means that the vent pipe 130 doubles as a venting system as well as a safety pressure relief device.

Steam diffuser 132 sits above an outlet 129 (that opens to atmosphere) of the vent pipe 130 in spaced relation to outlet 129 at a distance to provide enough back pressure so that the pressure in pressure chamber 154 will reach the 3-4 psi needed at higher elevations (e.g., about 6000 feet) above sea level. Vent pipe 130 has an inlet 131 that opens to pressure chamber 154 and vent pipe comprises a vent having an inlet that opens to pressure chamber 154 and an outlet that opens to atmosphere. Steam diffuser 132 also diffuses the steam into a larger loading chamber inside the top lid 102 that is vented to atmosphere by rear vents 104. Illustratively, steam diffuser 132 is spaced 5 mm (+/−typical tolerances) from outlet 129 of vent pipe 130, but can be spaced a distance other than 5 mm. The steam flows from this loading chamber out through the rear vents 104 and upon condensing, the condensed water falls down to the drip ring 122 and flows to a rear drip cup (not shown). The loading chamber and multiple rear vents 104 reduce the intensity and flow of the amount of steam exiting appliance 100.

In an aspect, control module 150 maintains a time of life counter, referred to in the flow charts of FIGS. 3A-3E as a time of life NTC counter, which is used to accumulate the total usage time of appliance 100. Usage time in this context means the time during which NTC's #1 and 2 are being used by control module 150 to sense temperature and control module 150 increments this time of life counter each time it reads the temperatures sensed by NTC's #1 and 2 by the interval at which NTC's 1 and #2 are read when they are on (such as 0.1 seconds as discussed above). When the accumulate usage time reaches a preset limit, such as 1,000 hours, control module 150 displays an “EOL” message on display 112. In an aspect, control module 150 also disables appliance 100 so that it can no longer be used as appliance 100 has then reached the end of its useful life.

Control module 150 includes electronic components, devices and circuitry for controlling appliance 100 including power switching devices (not shown) for switching electrical power to heater 152. It should be understood that control module 150 may be, be part of, or include an Application Specific Integrated Circuit (ASIC); an electronic circuit; a combinational logic circuit; a field programmable gate array (FPGA); a processor (shared, dedicated, or group) that executes code; programmable control system such as a processor based control system including a computer based control system, a process controller such as a PID controller, or other suitable hardware components that provide the described functionality or provide the above functionality when programmed with software as described herein; or a combination of some or all of the above, such as in a system-on-chip. The term module may include memory (shared, dedicated, or group) that stores code executed by the processor. The term software, as used above, may refer to computer programs, routines, functions, classes, and/or objects and may include firmware, and/or microcode. When it is stated that control module 150 performs a function or is configured to perform a function, such as energizing heater 152, it should be understood that control module 150 is configured to do so with appropriate logic (software, hardware, or a combination of both), such as by appropriate software, electronic circuit(s) including discrete and integrated logic, or combination thereof.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An automatic pressure canning appliance, comprising:
a main body in which a pot is received;
a heater disposed in the main body in close proximity to the pot when the pot is received in the main body;
a top lid movable between open and closed positions and sealing to the pot when in the closed position, the pot and lid when the lid is in the closed position and sealed to the pot defining a pressure chamber;
a pressure chamber vent having an inlet that opens to the pressure chamber and an outlet that opens to atmosphere;
a primary temperature sensor that senses a temperature in the pressure chamber;
a control module having a plurality of pre-programmed canning recipe programs, each of the pre-programmed canning recipes having a pre-programmed processing time, the primary temperature sensor coupled to the control module;
the appliance having a canning recipe program selection stage followed by a heating stage followed by a processing stage followed by a cooling stage;
the control module when the appliance is in the canning recipe program selection stage configured to be responsive to a user input via a control panel of the appliance to select one of the pre-programmed canning recipe programs;
the control module configured to transition the appliance to the heating stage in response to a user start input via the control panel of the appliance after selection of the pre-programmed canning recipe programs, the control module when the appliance is in the heating stage configured to energize the heater to heat the pressure chamber and to cycle the heater on and off to maintain the temperature in the pressure chamber sensed by the primary temperature sensor between an upper temperature set point and lower temperature set point that are both above a temperature at which water boils, wherein during the heating stage water received in the pot is boiled into steam and all air is vented from the pressure chamber via the vent creating a pure steam environment in the pressure chamber;
the control module configured to transition the appliance to the processing stage upon expiration of a predetermined heating time, wherein when the appliance is in the processing stage, the control module is configured to continue to cycle the heater on when the temperature sensed by the primary temperature sensor falls to the lower temperature set point and to cycle the heater off when the temperature sensed by the primary temperature sensor rises to the upper temperature set point wherein during the processing stage a pure steam environment is maintained inside the pressure chamber; and
the control module configured to transition the appliance to the cooling stage upon expiration of the pre-programmed processing time for the selected canning recipe program.

2. The appliance of claim 1 wherein when the appliance is in the cooling stage, the control module is configured to de-energize the heater and the pressure chamber depressurizes to atmospheric pressure.

3. The appliance of claim 1 further including a pre-heating stage that precedes the canning recipe program selection stage wherein in response to user input via the control panel, the control module is configured to energize the heater and in response to a pot temperature sensor sensing that a temperature of the pot is at or above a pre-heat temperature set point, the control module is configured to de-energize the heater for a short cooling period and then to reenergize the heater and configured to repeat de-energizing the heater for a short cooling period when the temperature of the pot is at or above the pre-heat temperature set point and then re-energize the heater after the short cooling period until a pre-heat period expires or the appliance has been transitioned to the canning recipe program selection stage in response to the user canning recipe program selection input.

4. The appliance of claim 1 wherein the lid includes a loading chamber therein, the vent is a vent pipe extending into the loading chamber and having an outlet above which a steam diffuser is disposed in spaced relation to the outlet of the vent pipe a distance to provide enough back pressure so that pressure in the pressure chamber can reach up to 8 psi at a higher elevation of 6000 feet above sea level.

5. The appliance of claim 4 wherein the steam diffuser is disposed 5 millimeters above the outlet of the vent pipe.

6. The appliance of claim 4 wherein the top lid includes a drip ring disposed around a lower periphery of the top lid.

7. The appliance of claim 6 wherein the pot is an inner pot and the main body includes an outer pot in which the inner pot is received, the main body including a shell that surrounds the outer pot in spaced relation to the outer pot.

8. The appliance of claim 4 wherein the upper temperature set point is in the range of 103° C. to 122° C. and the lower temperature set point is in the range of 95° C. to 101° C.

9. The appliance of claim 8 wherein the upper temperature set point is 103° C. and the lower temperature set point is 101° C.

10. The appliance of claim 1 further including a secondary temperature sensor that also senses the temperature in the pressure chamber, the control module configured to read the temperature sensed by secondary temperature sensor when it reads the temperature sensed by the primary temperature sensor and configured to determine that a fault exits if there is more than a predetermined temperature difference between the temperature sensed by the primary temperature sensor and the temperature sensed by the secondary temperature sensor, the controller configured to terminate selected canning recipe program and shut the heater off upon determining that a fault exists.

11. The appliance of claim 10 wherein the primary temperature sensor and the secondary temperature sensor are disposed at a bottom of the lid.

12. The appliance of claim 11 wherein the primary temperature sensor is an NTC temperature sensor and the secondary temperature sensor is an NTC temperature sensor.

13. An automatic pressure canning appliance, comprising:
a main body in which a pot is received;
a heater disposed in the main body in close proximity to the pot when the pot is received in the main body;
an top lid movable between open and closed positions and sealing to the pot when in the closed position, the pot and top lid when the top lid is in the closed position and sealed to the pot defining a pressure chamber;
a pressure chamber vent having an inlet that opens to the pressure chamber and an outlet that opens to atmosphere, the pressure chamber vent adapted to provide enough back pressure so that pressure in the pressure chamber can reach up to 8 psi at 6000 feet above sea level;
a primary temperature sensor that senses a temperature in the pressure chamber; and
a control module that when the appliance is in a processing stage, is configured to cycle the heater on and off to maintain a temperature sensed by the primary temperature sensor between an upper temperature set point and a lower temperature set point wherein the lower temperature set point is at least 100° C. and the upper temperature set point is above the lower temperature set point.

14. The appliance of claim 13 wherein the top lid includes a loading chamber therein, the vent is a vent pipe extending into the loading chamber and having an outlet above which a steam diffuser is disposed in spaced relation to the outlet of the vent pipe a distance to provide enough back pressure so that pressure in the pressure chamber can reach up to 8 psi at a higher elevation of 6000 feet above sea level.

15. The appliance of claim 14 wherein the steam diffuser is disposed 5 millimeters above the outlet of the vent pipe.

16. The appliance of claim 14 wherein the top lid includes a drip ring disposed around a lower periphery of the top lid.

17. The appliance of claim 16 wherein the pot is an inner pot and the main body includes an outer pot in which the inner pot is received, the main body including a shell that surrounds the outer pot in spaced relation to the outer pot.

18. The appliance of claim 13 wherein the upper temperature set point is in the range of 103° C. to 122° C. and the lower temperature set point is in the range of 95° C. to 101° C.

19. The appliance of claim 18 wherein the upper temperature set point is 103° C. and the lower temperature set point is 101° C.

20. The appliance of claim 19 wherein the primary temperature sensor is an NTC temperature sensor.

21. The appliance of claim 13 further including a heating stage that precedes the processing stage wherein when the appliance is in the heating stage, water received in the pot is boiled into steam and all air is vented from the pressure chamber via the vent creating a pure steam environment in the pressure chamber and the control module is
configured to cycle the heater on when the temperature sensed by the primary temperature sensor falls to the lower temperature set point and to cycle the heater off when the temperature sensed by the primary temperature sensor rises to the upper temperature set point and to transition the appliance to the processing stage upon expiration of a predetermined heating time, wherein the pure steam environment is
maintained in the pressure chamber during the processing stage.
